(19) United States
(12) Patent Application Publication
(10) Pub. No.: US 2022/0088836 A1
(43) Pub. Date: Mar. 24, 2022

(54) A COMPONENT FOR LIQUID HANDLING WITH SELF-CLEANING PROPERTIES

(71) Applicant: NIL TECHNOLOGY APS, Kongens Lyngby (DK)

(72) Inventors: Theodor Nielsen, Copenhagen (DK); Alicia Johansson, Copenhagen (DK); Lasse Hojlund Eklund Thamdrup, Copenhagen (DK)

(21) Appl. No.: 17/420,367

(22) PCT Filed: Jan. 24, 2020
(86) PCT No.: PCT/EP2020/051797

§ 371 Date: Jul. 1, 2021

(30) Foreign Application Priority Data
Jan. 24, 2019 (EP) 19153528.5

(51) Int. Cl. B29C 33/42; B29C 59/00; B29C 45/37; B29C 59/04

(52) U.S. Cl. CPC B29C 33/42; B29C 59/007; B29C 45/372; B29C 2059/023; B29C 59/002; B29C 2033/422; B29C 59/043

(57) ABSTRACT

The invention concerns a super hydrophobic surface for handling a liquid and/or able to be contacted by a liquid, said surface comprising at least one hydrophobic liquid contact surface portion, wherein said hydrophobic liquid contact surface portion presents a micro- and nano-meter hierarchical patterned structure, the structure comprising: —homogeneously distributed micrometre-sized pillars (1), and—homogeneously distributed nanometre-sized pillars (2), preferably said pillars (2) having a dimension below 1 micrometer, at the upper surface of the micrometre-sized pillars, and—nanometre-sized protrusions (3) at the upper surface of the nanometre-sized pillars, the protrusions being positioned in a non-periodic, irregular pattern. The invention also relates to the use of such surfaces with micro- and nano-meter hierarchical patterned structure, for example in handling hot liquids, and a corresponding manufacturing process, e.g. using an injection moulding process for producing the component in polymer.

### FIELD OF THE INVENTION

The present invention relates to a method for obtaining self-cleaning surfaces on polymer components with superhydrophobic or omniphobic properties. In particular the present invention relates to various uses self-cleaning surfaces on polymer components via a three level hierarchal micro- and nano-topology, and a manufacturing process for such surfaces on polymer components.

### BACKGROUND OF THE INVENTION

Superhydrophobic (SH) surfaces are abundant in nature. One of the most prominent and well-known examples is the lotus flower leafs, that contain a complex 3D topology. This effectively makes the surface SH and also self-cleaning (SC), as water droplets slide off the leafs and in the process collect particulate contamination sources.

Most synthetic polymer materials are intrinsically hydrophobic. This includes thermoplastic polymers such as cyclic-olefin copolymers and polypropylene that often are used to mass-produce plastic components by injection molding.

By employing high-tech fabrication techniques, masters or molds with complex surface topologies may be produced and these allow for mass-producing polymer parts by hot embossing, compression injection molding, injection molding and similar conventional production techniques. In literature, it is found that the SH properties of polymers are optimized by patterning them with hierarchal structures (i.e. micro-structures with a superposed nano-scale roughness). It is known in the art to make masters that allow for producing SH polymer surfaces by hot embossing. Promising results are obtained in e.g. cyclic-olefin copolymers, polypropylene and fluorinated polymers that have intrinsic WCAs above 100°. In hot embossing and injection molding, the surface relief of the master/mold must allow for smooth separation of the patterned plastic sample. Therefore, arbitrary 3D hierarchal structures cannot be transferred, although these may be the most ideal in terms of obtaining and efficient SH polymer surface. Structures with e.g. a high aspect ratio and/or negatively sloped sidewalls are in most cases prohibited.

International patent application WO 96/34697 discloses low energy surfaces based on nanostructured films exhibit advancing and receding contact angles for liquids such that (1) the difference between the advancing and receding contact angles approaches zero and (2) the advancing and receding contact angles approach 180°. The low energy surface comprises a nanostructured film coated with an organized molecular assembly (OMA). The chemical and wetting characteristics of the surface can be altered by changing the functionality of the OMA end groups exposed to the environment in contact with the surface of the nanostructured film. However, such OMA surfaces are not very durable over time and especially during use outside of laboratory conditions.

Hence, an improved method for introducing superhydrophobicity on plastic or polymer object surfaces would be advantageous, and in particular a more efficient method of introducing arbitrary hierarchical surface topologies on existing plastic or polymer objects resulting in superhydrophobicity would be advantageous.

The water repellent or hydrophobic property of the components can be obtained through different technologies. Chemical coatings have been used but their use can be unhealthy. An interesting technology is nano-imprint lithography which consists in imprinting micro- and nanostructures on components surfaces. International patent application WO 2013/131525 describes such types of structures and a method to imprint them: surfaces of injection molded polymers with such structures present good hydrophobic property, water drops rolling off these surfaces easily.

However, it has been observed that these structures provide efficient hydrophobicity with water used at ambient or cold temperature, yet, if water is hot, the hydrophobicity property decreases, and if water is mixed with a fat, sugar and/or protein component.

There is a need for providing surfaces presenting hydrophobic property whatever the temperature of the liquid in contact with the components, that is either cold, ambient or hot.

### SUMMARY OF THE INVENTION

The hydrophobic property is provided by the design of the surface of said liquid contact surface portion. Precisely, this surface presents a micro- and nano-meter hierarchical patterned structure with at least three levels.

Thus, in a first aspect, the invention relates to a component configured for handling a liquid and/or being able to be contacted by a liquid, said component comprising at least one liquid contact surface portion, the component being integrally formed with the liquid contact surface portion, wherein said liquid contact surface portion presents a micro- and nano-meter hierarchical patterned structure, said structure comprising:
homogeneously distributed micrometre-sized pillars,
homogeneously distributed nanometre-sized pillars, preferably said pillars having a dimension below 1 micrometer, at the upper surface of the micrometre-sized pillars, and
nanometre-sized protrusions at the upper surface of the nanometre-sized pillars, said protrusions being positioned in a non-periodic, irregular pattern.

The invention is particularly, but not exclusively, advantageous for obtaining a surface portion with one, or more, of the following properties:
omniphobicity,
super hydrophobicity,
self cleaning including less bacterial growth or bio-fouling,
reduced drag or friction,
anti condensation

When the present inventors set out to develop a self-cleaning polymer surface suitable for warm liquids, based on entirely micro- and nanostructures without any added coating or chemistry, the initial approach was to use a hierarchical surface structure where a microstructure is combined with a nanoroughness (micro-nano surface). These types of structures are well known from literature and a number of research groups have developed methods to fabricate these types of surfaces and characterized their performance by water contact angle measurements. Although there is a large amount of research results within this field, there is no clear conclusion about which structures and dimensions to use. According to theory, it is contemplated that the contact angle is depending on the surface area fraction in contact with the liquid, and it has been demonstrated in experiments that the smaller the surface area fraction the larger the contact angle.

In reality, contact angle measurements are quite complex, where the wetting performance of the surface is depending on the temperature, the humidity, the surface charge and the liquid used and it is often very difficult to predict the wetting performance of a surface in a given situation.

The self-cleaning polymer micro- and nanostructured surface that the present inventors developed had to meet a number of requirements where the most important requirement was that it had to be suitable for replication into a polymer material—preferably using a high volume manufacturing method, such as injection moulding.

To identify the optimal surface structure for warm liquids, the most straightforward approach was to test a number of different types of micro-nano structures by varying the shape, spacing and dimensions of the structures. The conclusion from the tests that the present inventors performed was that there was a number of surface designs that performed very well (high contact angle) when tested with liquids at room temperature. However, when warm liquids were used the contact angles were too low. As a result, it was concluded that micro-nano structures would not work satisfactory for warm liquids, and it became apparent that the present inventors had to go beyond conventional hierarchical surfaces and develop a new type of surface not yet reported in the literature.

The reason that is more difficult to achieve self-cleaning for warm liquids than room temperature liquids is current contemplated to be that the surface tension of water decreases with temperature, which makes the contact angle lower when the temperature increases.

The present invention is essentially to design a three-level hierarchical structure with a combination of one layer of microstructures and two layer of different nanostructures, though a higher number of layers are contemplated. The micro and first level nano structure is made with micro- and nano-lithography, which enables well-defined structures with straight sidewalls, which are suitable for injection moulding. The high control of the dimensions makes the surface area fraction in contact with liquid very predictable. The second level of nanostructures, being the third and upper most layer in the hierarchical structure, is a random nanograss structure, known from silicon processing.

Although two level structures are by far the most common types of self-cleaning surface, a few three-level structures have been presented. Mielonen et al. have recently reported a three-level micro-micro-nano surface with good wettability for standard contact angle measurements [K. Mielonen et. al, Journal of Micromechanics and Microengineering, 29 2019]. These structures are suitable for injection moulding but the main difference is the size of the middle layer which in Mielonen's case is microstructures and in the present invention is nanostructures, such a structure having a dimension, particular a spatial, average direction, such as width or height, of less than 1 micrometer, preferably less than 0.9, 0.8, 0.7, 0.6, 0.5, 0.4, 0.3, 0.2, or 0.1 micrometer. Some three-level structures are also known in nature, e.g. a gecko toe, but the present invention relates to components being artificially manufactured in an industrial process.

The component according to the present invention is integrally formed with the liquid contact surface portion, e.g. the component may be injection moulded together with the liquid contact surface portion. Thus, the skilled person would readily understand the component as being formed as a collective unit including the liquid contact surface portion as will be explained in more details below for a component in polypropylene, where all three levels in the hierarchical patterned structure are embossed together by a Ni stamp. In some embodiments, the liquid contact surface portion may also form only a portion of the component, e.g. a surface or a thin film being attached to the component.

According to preferred embodiments, the micro- and nano-meter hierarchical patterned structure comprises:
homogeneously distributed micrometre-sized pillars presenting a height of at least 3 μm, preferably comprised between 5 and 50 μm,
homogeneously distributed nanometre-sized pillars at the upper surface of the micrometre-sized pillars presenting a height comprised between 500 nm and 1000 nm, preferably comprised between 600 and 800 nm, and/or
nanometre-sized protrusions at the upper surface of the nanometre-sized pillars presenting a height comprised between 50 and 400 nm.

The first level of the structure comprises micrometre-sized pillars.

These micrometre-sized pillars present a shape and an upper surface configured to define a support for the homogeneously distributed nanometre-sized pillars.

These micrometre-sized pillars usually present a relatively homogeneous cross section all along their height and the cross section can present any shape (round, oval, square, rectangular, hexagonal). Alternatively, the cross section of the pillars can vary along the height. For example the pillars can present the shape of half spheres, the cross section of the pillar decreasing from the base to the top.

Preferably the micrometre-sized pillars are parallelepipedic or round pillars.

These pillars are homogeneously distributed. Preferably they are homogeneously distributed along lines, two next lines being either aligned (array distribution) or offset (hexagonal distribution). Preferably the lines are aligned (array distribution).

These micrometre-sized pillars can present a width comprised between 3 and 70 μm, preferably between 10 and 60 μm. The width represents the length of the side in case of a square shape or the diameter in case of a cylindrical shape. Preferably, the width represents ⅓ to 1 time the height.

These micrometre-sized pillars can be separated one from the others by a pitch of at most 8 times the width of said pillar. The pitch is the distance from the centre of one pillar to the centre of the next pillar.

The second level of the structure comprises homogeneously distributed nanometre-sized pillars present at the upper surface of the micrometre-sized pillars.

These nanometre-sized pillars present a shape and an upper surface configured to define a support for the nanometre-sized protrusions.

These nanometre-sized pillars usually present a relatively homogeneous cross section all along their height and the cross section can present any shape (round, oval, square, rectangular, hexagonal). Alternatively, the cross section of the pillars can vary along the height. For example the pillars can present the shape of half spheres, the cross section of the pillar decreasing from the base to the top.

Preferably the nanometre-sized pillars are round pillars.

These pillars are homogeneously distributed. Preferably they are homogeneously distributed along lines, two next lines being either aligned (array distribution) or offset (hexagonal distribution). Preferably the lines are aligned (array distribution).

These nanometre-sized pillars can present a width comprised between 400 and 1000 nm, preferably between 400 and 700 nm. Preferably, the width represents ⅕ to 1 time the height.

These nanometre-sized pillars can be separated one from the others by a comprised of at most 6 times the width of said pillar. The pitch is the distance from the centre of one pillar to the centre of the next pillar.

The third level of the structure comprises nanometre-sized protrusions at the upper surface of the nanometre-sized pillars. Contrary to the nanometre-sized pillars, the protrusions do not present well defined shapes. These protrusions are positioned in a non-periodic, irregular pattern at the upper surface of the nanometre-sized pillars.

These nanometre-sized protrusions present heights comprised between 10 and 400 nm and said height is inferior to the height of the nanometre-sized pillars on which upper surface they protrude. The nanometre-sized protrusions present a minimum density of 10⁵ protrusions/mm², preferably within an interval of 10⁵ to 10⁸ protrusions/mm².

Typically, the nanometer-sized protrusions may have an aspect ratio (A), i.e. height/width of structure on average, of minimum 10, 1, 0.1 or 0.01. Alternatively, the nanometer-sized protrusions may have an aspect ratio (A), i.e. height/width of structure on average, of maximum 10, 1, 0.1 or 0.01.

It is to be understood that the density is calculated on an average basis as will be appreciated by a person working with micro-technologies. The concept of a non-period, irregular pattern is to be understood by the skilled person as seen on as seen or viewed on a nanometer scale, e.g. using scanning electron microscopy (SEM) or an atomic force microscopy (AFM). Using for example a pixel size of approximately 2-20 nm in SEM, the master structure will be shown to have a protrusion distribution with such a pattern.

In some embodiments, the micro- and nano-meter hierarchical patterned structure may comprise at least three different height levels above the surface of the component, each of
said homogeneously distributed micrometre-sized pillars,
said homogeneously distributed nanometre-sized pillars, and
said nanometre-sized protrusions,

thereby being positioned in substantively separate and non-overlapping height intervals above and across the surface of the component. Thus, by three, or more layers, is generally understood layers at different heights over the surface of the component, though the skilled person acknowledges that there could in practise be some degree of overlap between the height intervals due to manufacturing tolerances and imprecision, for example depending on how the next level is manufactured on top of the previous level. This is also what is implied by the meaning of the term ‘hierarchical structure’, i.e. one level on top of the previous level.

In advantageous embodiments, the nanometre-sized protrusions may have a density of at least 10⁵ protrusions/mm² and the non-periodic, irregular pattern originates from a moulding, an embossing or a casting form, said moulding, embossing or casting form having the corresponding non-periodic, irregular pattern from a semiconductor material with the equivalent nano-grass surface structure in this non-periodic, irregular pattern. Moreover, the density can be at least 10⁶ protrusions/mm², at least 10⁷ protrusions/mm², or at least 10⁸ protrusions/mm². These protrusions are positioned in a non-periodic, irregular pattern. Typically, the density can be in the interval from approximately 10⁵ to 10⁸ protrusions/mm², preferably in the interval from approximately 10⁶ to 10⁷ protrusions/mm².

In advantageous embodiments, wherein the component is made, at least partly, of a polymer, and is preferably produced by injection molding embossing, or roll-to-roll imprinting. Additionally, the micro- and nano-meter hierarchical patterned structure may be imprinted at the surface of the component during an injection molding operation, an embossing, or a roll-to-roll imprinting.

Generally the polymer the component is made of is a polymer not charged with fibres. Actually, the presence of fibres may not enable the molding of the patterned surface as desired. The polymer is preferably polypropylene, cyclic-olefin copolymers or polyamide. The polymer may be reinforced with nanoparticles.

In one embodiment, the component can be a water tank, tube, hose, surface of a vessel, other marine constructions, etc., and at least one internal lateral side wall of the tank presents at least one hydrophobic liquid contact surface portion such as described above.

In yet another embodiment, the micrometre-sized pillars of the micro- and nano-meter hierarchical patterned structure present a width comprised between 3 and 70 μm, preferably between 10 and 60 μm.

In yet another embodiment, the micrometre-sized pillars of the micro- and nano-meter hierarchical patterned structure are separated one from the others by a pitch of at most 8 times the width of said pillars.

In yet another embodiment, the nanometre-sized pillars of the micro- and nano-meter hierarchical patterned structure present a width comprised between 400 and 1000 nm, preferably between 400 and 700 nm.

In yet another embodiment, the nanometre-sized pillars of the micro- and nano-meter hierarchical patterned structure are separated one from the others by a pitch of at most 6 times the width of said pillars.

In yet another embodiment, the micrometre-sized pillars are parallelepipedic or round.

In yet another embodiment, the nanometre-sized pillars are round or truncated cones.

In a second aspect, the invention relates to use of a hydrophobic liquid contact surface portion presenting a micro- and nano-meter hierarchical patterned structure in at least one component for handling a liquid having a temperature of at least 35 degrees Celsius, said component being integrally formed with said hydrophobic liquid contact surface portion, said structure comprising:
homogeneously distributed micrometre-sized pillars, and
homogeneously distributed nanometre-sized pillars at the upper surface of the micrometre-sized pillars, and
nanometre-sized protrusions at the upper surface of the nanometre-sized pillars, said protrusions being positioned in a non-periodic, irregular pattern.

Thus, advantageously the invention may be applied for hot liquid, where test results, cf. example section below, indicate that the invention is superior to the prior art solutions available. Temperatures of at least 30, 40, 45, 50, 55, 60, 65, 70, 75, 80, 85, 90, 95, 100 degrees Celsius are contemplated for application within the context of the present invention. Thus, water below it's boiling point can be handled, if the component itself can safely and reliably handle the hot water without deterioration and/or malfunctioning. Thus, if the component is a polymer, the said polymer is capable of withstanding hot water, possibly under pressure. Additionally or alternatively, the invention may be applied for handling liquids with even higher temperatures, such as at least 100, 200, or 300 degrees Celsius, again, respecting the working temperature limit of the component as the skilled person will readily understand. Furthermore, the liquid could be alternatively be a vapor.

Specifically, the use may relate to a component for handling a liquid being applied for:
liquid processing, transport, handling or storage, preferably the liquid being water or one or more water-based liquids, including any microfluidic devices,
transparent surfaces and components with transparent surface(s),
medical devices, or
food and beverages handling including packaging.

A more elaborated list of possible applications is provided in the Detailed Description below. In connection with liquid handling and transport, a particular advantage of the invention is that the liquid drag may be significantly reduced, i.e. the drag or liquid friction of, for example, a liquid being transported through a pipe, or water passing a ship, or a marine construction.

In a third aspect, the invention relates to a manufacturing process for manufacturing a polymer component according to any of the preceding claims, the process comprises:
micro and nano-lithographic processing a semiconductor wafer, preferably a silicium wafer, the semiconductor wafer having a three-level micro- and nano-meter hierarchical patterned structure, the upper-most level having a nano-meter structure being produced by a process resulting in a nano-grass surface structure with a non-periodic, irregular pattern,
transferring said hierarchical patterned structure into an injection molding tool, embossing tool, or roll-to-roll imprinting tool,
forming a polymer component for liquid handling, said polymer component having a liquid contact surface portion presenting a micro- and nano-meter hierarchical patterned structure, the polymer component being integrally formed with the liquid contact surface portion, said structure comprising:
   homogeneously distributed micrometre-sized pillars,
   homogeneously distributed nanometre-sized pillar, preferably said pillars having a dimension below 1 micrometer, at the upper surface of the micrometre-sized pillars, and
   nanometre-sized protrusions at the upper surface of the nanometre-sized pillars, said protrusions being positioned in a non-periodic, irregular pattern.

In advantageous embodiments, the transferring of said hierarchical patterned structure into an injection molding tool, embossing tool, or roll-to-roll imprinting tool is performed with an intermediate metal insert, such as a Ni shim, being attached to an inner surface of the tool prior to manufacturing. Additionally or alternatively, the tool, or a part thereof, such as an, toused in the injection molding tool, the embossing tool, or the roll-to-roll imprinting tool is made of steel, or steel alloys, which is well-suited for mass scale manufacturing of components. The skilled person will understand that such inserts and/or tools may be coated and/or surface treated for increased performance and durability.

In a fourth aspect, the invention relates a polymer injection molding tool, a polymer embossing tool, or a polymer roll-to-roll imprinting tool configured for manufacturing a component according to the second aspect comprising a patterned surface for molding the hydrophobic liquid contact surface portion presenting the micro- and nano-meter hierarchical patterned structure according to first aspect.

In yet another aspect, the invention relates to a component configured for handling a liquid and/or being able to be contacted by a liquid, said component comprising at least one liquid contact surface portion, wherein said liquid contact surface portion presents a micro- and nano-meter hierarchical patterned structure, said structure comprising:
homogeneously distributed micrometre-sized pillars,
homogeneously distributed nanometre-sized pillars, preferably said pillars having a dimension below 1 micrometer, at the upper surface of the micrometre-sized pillars, and
nanometre-sized protrusions at the upper surface of the nanometre-sized pillars, said protrusions being positioned in a non-periodic, irregular pattern. This aspect may be combined with any of the second to fourth aspects i.e. without the component being integrally formed with the hydrophobic liquid contact surface portion,

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

Another aspect relates to fabrication of the hierarchical structure by forming a template containing the super hydrophobic surface structure and transferring that structure to the component, said fabrication method comprising steps of standard UV-lithorgaphy and dry etching to pattern the micrometer-sized pillars (first level) in a Si wafer and standard DUV-lithography and dry etching to pattern the nanometer sized pillars (second level). The nanometer-sized protrusions (third level) can be fabricated by a black Si process. The Si wafer with the three level structures can be used directly for replication into plastic polymer or can be replicated into a Ni shim/steel mould/polymer mould which is used for polymer replication. The polarity (pillars or holes) of the pattern in the Si wafer depend on the number of replication steps.

The replication into plastic polymer can be done using nanoimprinting, embossing (incl. hot embossing), injection moulding, roll-to-roll (R2R) replication or other similar technique.

### BRIEF DESCRIPTION OF THE DRAWINGS

The characteristics and advantages of the invention will be better understood in relation to the following figures wherein:

FIGS. 1a-1c illustrates a first micro- and nano-meter hierarchical patterned structure used as a hydrophobic liquid contact surface portion according to the invention,

FIG. 2 illustrates a second micro- and nano-meter hierarchical patterned structure used as a hydrophobic liquid contact surface portion according to the invention,

FIG. 3 illustrates a third micro- and nano-meter hierarchical patterned structure used as a hydrophobic liquid contact surface portion according to the invention,

FIG. 4 illustrates a micro- and nano-meter hierarchical patterned structure used as a hydrophobic liquid contact surface portion according to the state of the art,

FIG. 5 is a sketch of the self-cleaning effect of the super hydrophobic surface, and

FIG. 6 shows the drag reduction of the super hydrophobic surface

### DETAILED DESCRIPTION OF THE DRAWINGS

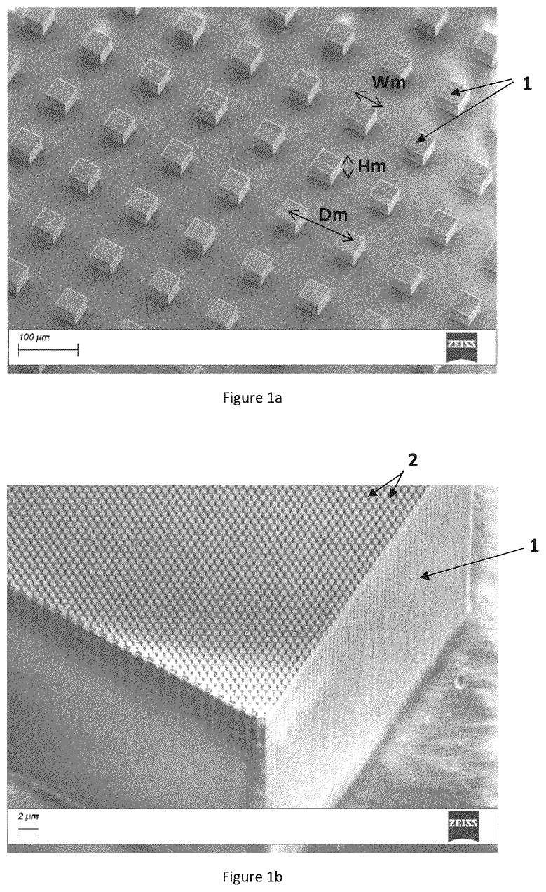

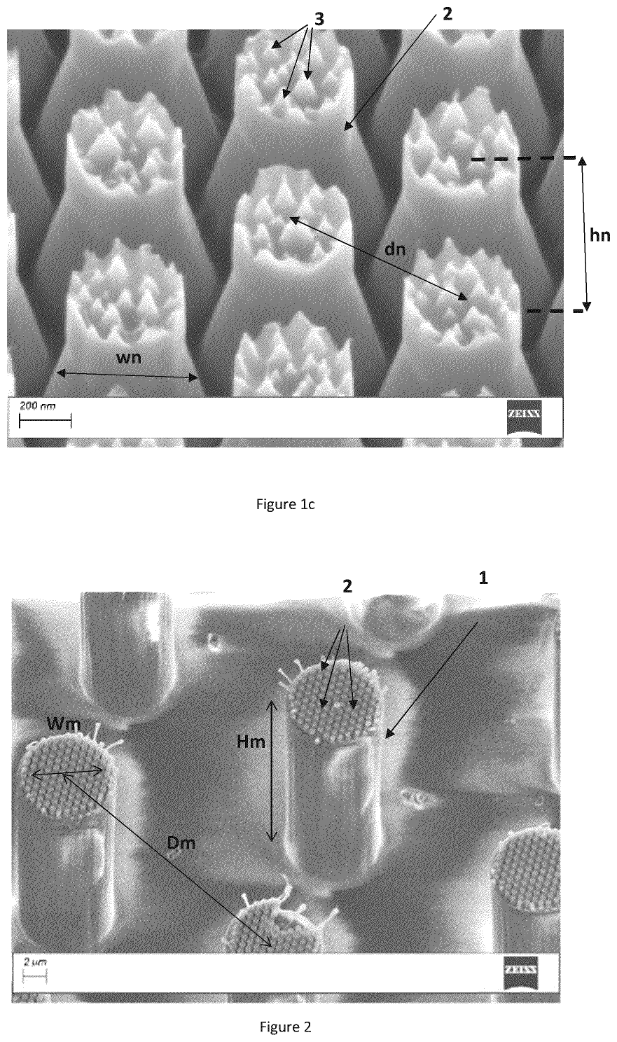

FIGS. 1a-1c illustrate a first micro- and nano-meter hierarchical patterned structure used as a hydrophobic liquid contact surface portion in the components of beverage dispensing apparatuses according to the invention. In order to test the property of the structure, said structure was manufactured in polypropylene foil. Ni stamps presenting the reverse design were used for embossing the structure in the plastic foil. The process for manufacturing the Ni stamps and embossing polypropylene plastic is known and described in WO 2013/131525, which is incorporated by reference in its entirety, for two levels with a microstructure and, on top thereof, a nanostructure from nano-grass.

FIGS. 1a-1c show SEM (Scanning Electron Microscope) images of the hierarchical structure. In these images, the view are tilted meaning that, depending on the angle taken for the view, the pillars and protrusions can appear slightly larger than in the reality or of smaller height than in the reality.

FIG. 1a is a tilted SEM image showing the micrometre-sized square pillars 1 homogeneously distributed along a matrix of lines and columns. The pillars are identical and present a height Hₘ of 40 μm and a width Wₘ of 40 μm. The pillars are separated one from the others by a pitch Dₘ (distance centre to centre) of 115 μm.

FIG. 1b is a magnified tilted SEM view of one pillar of FIG. 1a: it illustrates nanometre-sized pillars 2 positioned at the upper surface of the micrometre-sized pillars 1. These nanometre-sized pillars are homogeneously distributed along a matrix of lines and columns. Next lines are offset one to the other. The pillars are identical.

FIG. 1c is a magnified photo of several nano-sized pillars of FIG. 1b: the nano-sized pillars 2 present a round section with a height hₙ of 750 nm. The pillars are slightly conical, the round shape at the base stretching at the top of the pillars. The width wₙ at the base is of 500 nm. The pillars are separated one from the others at the base by a maximal pitch dₙ of 750 nm.

The photo of FIG. 1c shows the upper surface of the nano-sized pillars. The upper surface comprises nanometre-sized protrusions 3: these nanometre-sized protrusions present irregular heights, yet these heights remain comprised between 100 and 400 nm. The density of these nanometre-sized protrusions at the upper surface of the pillars is of about 10⁷ protrusions/mm². However, density can be at least 10⁵ protrusions/mm², at least 10⁶ protrusions/mm², at least 10⁷ protrusions/mm², at least 10⁸ protrusions/mm². These protrusions are positioned in a non-periodic, irregular pattern.

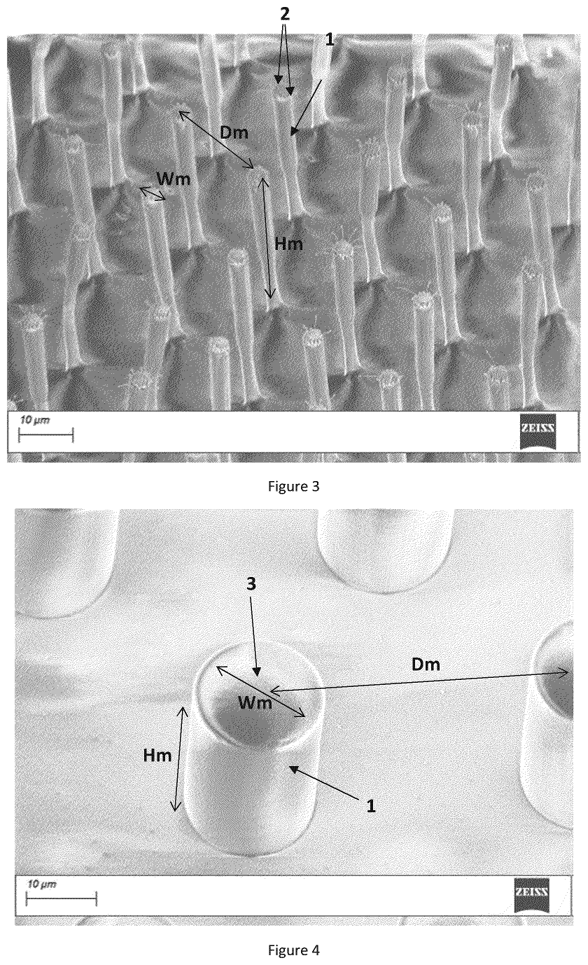

FIG. 2 is a photo showing a second micro- and nano-meter hierarchical patterned structure used as a hydrophobic liquid contact surface portion in the components of beverage dispensers according to the invention.

FIG. 2 is a magnified tilted SEM view of cylindrical micrometre-sized pillars 1 with cylindrical nano-sized pillars 2 rising from their top surface. These micrometre-sized pillars 1 are homogeneously distributed along a matrix of lines and columns. Next lines are offset one to the other. The pillars are identical. The nanometre-sized protrusions at the top of the nano-sized pillars 2 are not visible in the photo at this magnification, yet they are present. These nanometre-sized protrusions present the same features as those present in the structure of FIG. 1c.

The micrometre-sized cylindrical pillars 1 are homogeneously distributed along a matrix of lines and columns. The pillars 1 are identical and present a height Hₘ of 20 μm and a width Wₘ of 5 μm. The pillars are separated one from the others by a pitch Dₘ (distance centre to centre) of 15 μm.

The nanometre-sized cylindrical pillars 2 are homogeneously distributed along a matrix of lines and columns. The pillars 2 are identical and present a height hₙ of 750 nm and a width wₘ of 500 nm. The pillars are separated one from the others by a pitch dₙ (distance centre to centre) of 750 nm.

FIG. 3 is a photo showing a third micro- and nano-meter hierarchical patterned structure used as a hydrophobic liquid contact surface portion in the components of beverage dispensers according to the invention.

FIG. 3 is a magnified tilted SEM view of cylindrical micrometre-sized pillars 1 with slightly visible cylindrical nano-sized pillars 2 rising from their top surface. These micrometre-sized pillars 1 are homogeneously distributed along a matrix of lines and columns. Next lines are offset one to the other. The pillars are identical. The nanometre-sized protrusions at the top of the nano-sized pillars 2 are not visible in the photo at this magnification, yet they are present. These nanometre-sized protrusions present the same features as those present in the structure of FIG. 1c.

The micrometre-sized cylindrical pillars 1 are homogeneously distributed along a matrix of lines and columns. The pillars 1 are identical and have been manufactured from an Ni stamp presenting a reverse design to produce pillars 1 presenting a height Hₘ of 30 μm and a width Wₘ of 5 μm. Yet, during the step of removing the propylene foil from the Ni stamp, pillars 1 were stretched resulting in pillars with a slightly higher final height. Pillars are separated one from the others by a pitch Dₘ (distance centre to centre) of 15 μm.

The nanometre-sized cylindrical pillars 2 are homogeneously distributed along a matrix of lines and columns. The pillars 2 are identical and, similarly to pillars 1 have been stretched during the manufacturing step; the Ni stamp was configured to produce pillars 2 of a height hₙ of 750 nm and a width wₘ of 500 nm. The pillars are separated one from the others by a pitch do (distance centre to centre) of 750 nm.

FIG. 4 is a photo showing a micro- and nano-meter hierarchical patterned structure used as a hydrophobic liquid contact surface portion according to the state of the art. FIG. 4 is a tilted SEM image showing the micrometre-sized round pillars 1 homogeneously distributed along a matrix of lines and columns in an hexagonal array. All the pillars are identical and present a height Hₘ of 16 μm and a diameter Wₘ of 18 μm. The pillars are separated one from the others by a pitch Dₘ of 50 μm.

Nanometre-sized protrusions 3 at the top of the micro-sized pillars 1 are not visible in the illustrated figure at this magnification, yet they are present. Nanometre-sized protrusions presenting a height comprised between 200 and 400 nm at a density of 10⁷ protrusions/mm² were measured. These protrusions are positioned in a non-periodic, irregular pattern.

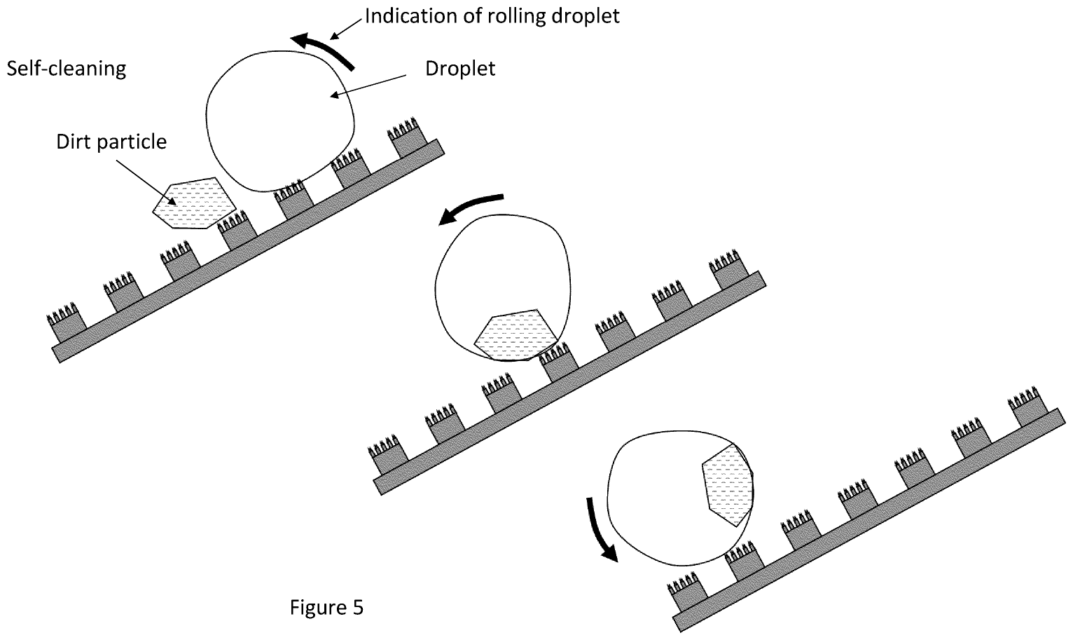

FIG. 5 is a sketch of the self-cleaning effect of the super hydrophobic surface. On classical surfaces the droplets are more or less immobilized on the surface. On the super hydrophobic surface, the droplets rolls along the surface. Dirt particles are captured by the droplets and transported to the edges of the surface, where they escape from the surface and leave the surface clean.

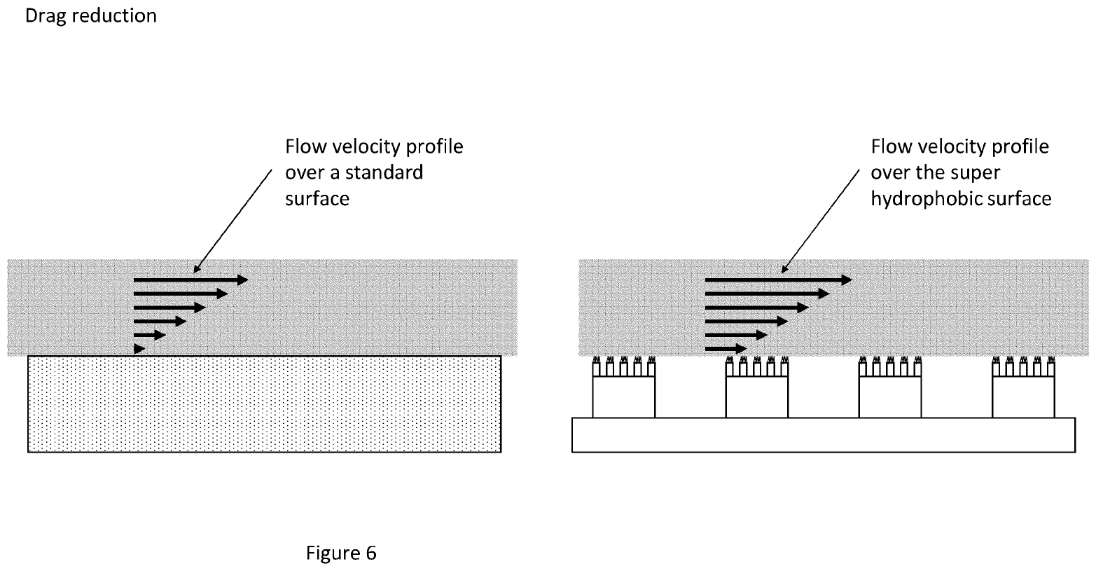

FIG. 6 shows the drag reduction of the super hydrophobic surface. The figure shows the velocity profile of a liquid flowing past a surface. On a classical surface the velocity of the liquid close to the surface will be zero or close to zero. On the super hydrophobic surface, the contact area between the liquid and the surface is very small. This causes the liquid to slip on the surface with a non-vanishing velocity of the liquid close to the surface. This results in reduced drag on objects moving through the liquid and reduce flow resistance when liquid is moving past the surface.

### EXAMPLES

The hydrophobic properties of the foils of plastic describes in FIGS. 1a-1c, 2, 3 and 4 were tested with hot beverages.

The procedure of the test consisted in:
cleaning the foil with ethanol and then deionized water,
positioning the foil according to an inclined angle of 5° or 45° with horizontal, that is reproducing a very small inclination inside a component of a beverage dispenser,
depositing manually a drop (volume of 50 uL) of hot beverage on the foil. The hot beverage presented a temperature of 70° C. and consisted in water, coffee, skimmed milk, fat milk or chocolate, and
observing the movement of the drop on the surface of the foil.

| | |
|---|---|
| Type of | |
| patterned | |
| structure | Result of the test |

According to the invention

| | |
|---|---|
| micro + nano + | drops of hot water rolled |
| nano-meter | immediately |
| hierarchical | from the foil inclined at 5°, |
| patterned | drops of hot skimmed milk and |
| structure of | fat milk rolled immediately |
| FIGS. 1a-1c | from the foil if the |
| | foil was inclined by 45°. |
| | drops of coffee and |
| | chocolate did not roll |
| | off even inclined at 45°. |
| micro + nano + | drops of hot water rolled |
| nano-meter | immediately from |
| hierarchical | the foil inclined at 5°, |
| patterned | drops of hot skimmed milk, |
| structures of | fat milk, coffee and chocolate |
| FIGS. 2 and 3 | rolled immediately from the foil |
| | if the foil was inclined by 45°. |

According to the prior art

| | |
|---|---|
| micro + | drops of hot water rolled |
| nano-meter | immediately from the |
| hierarchical | foil inclined at 5°, |
| patterned | drops of hot beverages did |
| structure | not roll off from the |
| of FIG. 4 | foil inclined by 45°. |

The results of the present invention are clearly better than the prior art solutions, such as WO 2013/131525. This structure increases the hydrophobic properties of the surface, but does not in general provide a self-cleaning surface for hot liquids. The three level structures of the present invention results in a much higher contact angle, lower roll-off angles and a surface which is more stable towards immersion in water and impinging droplets.

Uses of the Super Hydrophobic Surface.

In general, super hydrophobic surfaces possess characteristics of self-cleaning, drag reduction, anti-condensation and anti-bacterial. The value of these characteristics is important in a range of different application areas:

1. Medical: medical devices including glasses, prescription lenses, watches, hearing aids, ostomy pouching systems, endoscopes, patches, bandages, and a prosthesis

2. Water transport including surfaces of boats and ships. In this area drag reduction is directly coupled to fuel reduction of increased speed. The drag reduction comes both from the low drag coefficient of the surface itself and the self cleaning effect that continues to keep the surface clean and smooth.

3. Water distribution systems including tubes, pipes, and microfluidic systems. In these systems, the reduced drag coefficient increases the flow capacity of the systems and the self cleaning effect ensures the system to stay clean without deposits. Also the antibacterial effect prevents the systems from being contaminated by e.g. harmful bacteria.

4. Water sports including reduced friction in equipment and clothing. In this area the value of the surfaces is mainly to reduce drag in order to improve performance. Surf boards, swim suits etc. with lower friction will inevitably result in improved performance.

5. Water containers including tanks, bottles, cans, barrels etc. In this area mainly the self cleaning and antibacterial effects are important to keep the containers clean and un contaminated by bacteria.

6. Industrial equipment including heaters, boilers, heat exchangers, pumps, compressors: For these uses it is important to reduce deposits from the water that could limit performance. Also friction reduction is important for capacity and energy use in e.g. pumps and compressors. In some instances prevention of condensation, by the anti-condensation characteristic will improve the efficiency of heat exchangers and compressors because they can run closer to or even beyond the condensation limit.

7. Appliances including washing machines, dishwashers, fridges etc.: Self-cleaning of surfaces will help keeping the machines clean and tidy both on the visual surfaces and inside. Clean machines are known to have a longer lifetime and use less energy.

8. Transparent surfaces including mirrors, displays, dashboards, windows (also automotive): All these uses rely on a clean and transparent surface. Anti condensation reduces formation moisture to reduce transparency, the reduced friction will allow droplets to roll off the surface easily and the self-cleaning effect will ensure that dirt in the surface will be removed with the droplets.

9. Food equipment including industrial equipment: self-cleaning surfaces are important to limit the energy use associated with cleaning of the machines and will prevent contamination by harmful bacteria. Trays, baskets, crates for storage, transportation and serving of food can become easier to clean.

10. Beverage dispensers incl. storage of liquid, particular the internal wall of a storage.

11. Packaging: In some instances it is desirable to apply packaging that reduces the risk for access of humidity, moisture and water. A packaging material with an anti-condensation surface will help prevent this.

12. Toys including baby toys and water toys: These toys often has a tendency to form a biofilm that may contain harmful bacteria. A self-cleaning surface will help to prevent this.

13. Outdoor lighting (including automotive): these uses rely on a clean and transparent surface for light to escape undisturbed from the device. Anti condensation reduces formation moisture to reduce transparency, the reduced friction will allow droplets to roll off the surface easily and the self-cleaning effect will ensure that dirt in the surface will be removed with the droplets.

14. Lab-on-chip systems or microfluidic devices for biomedical or liquid analysis: superhydrophobic surface properties can help to control the flow of liquid.

15. Waste reduction and recyclability: Medical containers can be emptied more easily there by ensuring that the patient receives all the prescribed medication. Food containers can be more easily emptied which reduces food waste and makes the container more suitable for recycling since it is clean.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification. As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

micro-sized pillar 1
nano-sized pillar 2
nanometre-sized protrusion 3

1. A component configured for handling a liquid and/or being able to be contacted by a liquid, said component comprising at least one liquid contact surface portion, the component being integrally formed with the liquid contact surface portion, wherein said liquid contact surface portion presents a micro- and nano-meter hierarchical patterned structure, said structure comprising:
homogeneously distributed micrometre-sized pillars,
homogeneously distributed nanometre-sized pillars, said pillars having a dimension below 1 micrometer, at the upper surface of the micrometre-sized pillars, and
nanometre-sized protrusions at the upper surface of the nanometre-sized pillars, said protrusions being positioned in a non-periodic, irregular pattern.

2. The component according to claim 1, wherein the micro- and nano-meter hierarchical patterned structure comprises at least one of:
homogeneously distributed micrometre-sized pillars presenting a height of at least 3 μm,
homogeneously distributed nanometre-sized pillars at the upper surface of the micrometre-sized pillars presenting a height comprised between 500 nm and 1000 nm, or
nanometre-sized protrusions at the upper surface of the nanometre-sized pillars presenting a height comprised between 50 and 400 nm.

3. The component according to claim 1, wherein the micro- and nano-meter hierarchical patterned structure comprises at least three different height levels above the surface of the component, each of
said homogeneously distributed micrometre-sized pillars,
said homogeneously distributed nanometre-sized pillars, and
said nanometre-sized protrusions
thereby being positioned in substantively separate and non-overlapping height intervals above and across the surface of the component.

4. The component according to claim 1, wherein the nanometre-sized protrusions have a density of at least 105 protrusions/mm2 and the non-periodic, irregular pattern originates from a moulding, an embossing or a casting form, said moulding, embossing or casting form having the corresponding non-periodic, irregular pattern from a semiconductor material with the equivalent nano-grass surface structure in this non-periodic, irregular pattern.

5. The component according to claim 1, wherein the component is made, at least partly, of a polymer, and is preferably produced by injection molding embossing, or roll-to-roll imprinting.

6. The component according to claim 1, wherein the micro- and nano-meter hierarchical patterned structure is imprinted at the surface of the component during an injection molding operation, an embossing, or a roll-to-roll imprinting.

7. Use of a hydrophobic liquid contact surface portion presenting a micro- and nano-meter hierarchical patterned structure in at least one component for handling a liquid having a temperature of at least 35 degrees Celsius, said component being integrally formed with said hydrophobic liquid contact surface portion, said structure comprising:
homogeneously distributed micrometre-sized pillars, and
homogeneously distributed nanometre-sized pillars at the upper surface of the micrometre-sized pillars, and
nanometre-sized protrusions at the upper surface of the nanometre-sized pillars, said protrusions being positioned in a non-periodic, irregular pattern.

8. Use according to claim 7, wherein the component for handling a liquid is applied for:
liquid processing, transport, handling or storage, the liquid being water or one or more water-based liquids, including any microfluidic devices,
transparent surfaces and components with at least one-transparent surface,
medical devices, or
food and beverages handling including packaging.

9. A manufacturing process for manufacturing a polymer component, the process comprises:
micro and nano-lithographic processing a semiconductor wafer having a three-level micro- and nano-meter hierarchical patterned structure, an upper-most level having a nano-meter structure being produced by a process resulting in a nano-grass surface structure with a non-periodic, irregular pattern,
transferring said hierarchical patterned structure into an injection molding tool, embossing tool, or roll-to-roll imprinting tool,
forming a polymer component for liquid handling, said polymer component having a liquid contact surface portion presenting a micro- and nano-meter hierarchical patterned structure, the polymer component being integrally formed with the liquid contact surface portion,
said structure comprising:
homogeneously distributed micrometre-sized pillars,
homogeneously distributed nanometre-sized pillars having a dimension below 1 micrometer, at the upper surface of the micrometre-sized pillars, and
nanometre-sized protrusions at the upper surface of the nanometre-sized pillars, said protrusions being positioned in a non-periodic, irregular pattern.

10. The manufacturing process according to claim 9, wherein the transferring of said hierarchical patterned structure into an injection molding tool, embossing tool, or roll-to-roll imprinting tool is performed with an intermediate metal insert, attached to an inner surface of the tool prior to manufacturing.

11. The manufacturing process according to claim 9, wherein the injection molding tool, the embossing tool, or the roll-to-roll imprinting tool is made of steel, or steel alloys.

12. (canceled)
